(19) United States
(12) Patent Application Publication
(10) Pub. No.: US 2004/0155380 A1
(43) Pub. Date: Aug. 12, 2004

(54) Molding compound

(75) Inventors: John E. Kendall, Charleston, WV (US); Gary C. Rex, Canton, GA (US); Robert L. Seats, Beckley, WV (US); David H. Bank, Midland, MI (US); Robert P. Dion, Horgen (CH)

Correspondence Address: DOBRUSIN & THENNISCH PC, 401 S OLD WOODWARD AVE, SUITE 311, BIRMINGHAM, MI, 48009, US

(73) Assignee: Dow Global Technologies Inc., Midland, MI (US)

(21) Appl. No.: 10/723,096

(22) Filed: Nov. 26, 2003

Related U.S. Application Data
(60) Provisional application No. 60/436,295, filed on Dec. 23, 2002.

(51) Int. Cl. B29C 71/00

(52) U.S. Cl. 264/257; 264/324

(57) ABSTRACT

There is disclosed a molding compound. The molding compound preferably includes a macrocyclic oligoester that reacts with itself, a secondary compound or another macrocyclic oligoester during molding of the molding compound. Exemplary secondary compounds include a cyclic ester, a dihydroxyl-functionalized polymer or the like.

### CLAIM OF BENEFIT OF FILING DATE

The present application claims the benefit of the filing date of U.S. Provisional Application Serial No. 60/436,295, filed Dec. 23, 2002, hereby incorporated by reference.

### TECHNICAL FIELD

The present invention relates to molding compounds such as sheet molding compounds or the like.

### BACKGROUND

For many years, industry has sought to design improved molding compounds and particularly sheet molding compounds due to the many uses to which such molding compounds may be applied. Typically, sheet molding compounds include components such as a polyester resin, a filler, a reinforcement material, and other ingredients. Sheet molding compounds may also include one or more other agents such as a reactive monomer, a crosslinking agent, a copolymerization agent, or an initiator. Moreover, some sheet molding compounds may include one or more additives such as rheology modifiers, mold release agents, dimensional stability agents, stabilizers, antioxidants, or low profile agents.

While improvements in molding compounds have been accomplished, many basic compounds still exhibit processing limitations. For example, conventional sheet molding compounds are required to undergo a maturation process to age and thicken the compound before the compound may be formed into parts or components. This maturation process usually takes place over a time span of three to five days thereby slowing production. Even after maturation, many conventional sheet molding compounds typically have relatively short storage lives, which requires that the molding compounds must be quickly formed into parts or components. Additionally, the relative shortness of the storage lives imposes transport constraints upon the sheet molding compounds. Moreover, conventional sheet molding compounds are often supplied with one or more barrier films, which must be removed prior to molding of the compounds and such films must typically be discarded thereby increasing labor and waste handling issues.

Continued efforts to improve various aspects of molding compounds are exemplified in U.S. Pat. Nos. 5,552,478; 5,756,554; 5,756,644; 5,795,423; 5,932,666; 6,369,157; 6,498,651; all of which are incorporated herein by reference for all purposes. Notwithstanding these efforts, there remains a need for a molding compound and, more particularly, a sheet molding compound (SMC), which accomplishes at least one, and more preferably a combination of at least two or more advantageous features (as compared with conventional compounds), selected from: i) shorter processing times; ii) fewer processing steps; iii) reduction in required processing equipment and waste materials; iv) extended storage lives and v) compatibility with other chemical components.

### SUMMARY OF THE INVENTION

The present invention meets the above needs and is predicated upon the discovery of an improved resin for use in combination with or, more preferably, as a substitute for conventional polyesters that are used in molding compounds or specifically, a preferred resin for use herein includes a macrocyclic oligoester (e.g., without limitation, a cyclic butylene terephthalate). These have been particularly effective for forming improved molding compounds, especially (though not necessarily) when they are combined with one or more secondary compounds such as cyclic esters, dihydroxyl-functionalized polymers or combinations thereof. Accordingly, the present invention provides improved molding compounds, articles made therefrom and processes for making or using the same.

### DETAILED DESCRIPTION OF THE PREFERRED EMBODIMENT

The present invention is premised upon the formation of a molding compound. The molding compound has been found to be particularly useful as a sheet molding compound. Though often referred to herein as sheet molding compounds it should be appreciated that the invention is not limited to only sheet molding compounds; other molding compounds are also contemplated, such as a pre-formed molding compound, bulk molding compound or the like.

The molding compound preferably includes one or more of the following:

(a) at least one macrocyclic oligoesters;

(b) at least one molding compound catalyst;

(c) at least one ingredient selected from reinforcement materials, fillers, or a combination thereof.

In an additional preferred embodiment the molding compound further includes one or more additional ingredients for tailoring the performance of a material for a particular application.

While the sheet molding compound may include various materials, which may be supplied as resins or otherwise, the compound preferably includes one or more macrocyclic oligoesters, and one or more secondary compounds such as a cyclic ester or a dihydroxyl-functionalized polymer. Examples of such cyclic esters, macrocyclic esters and dihydroxyl-functionalized polymers are discussed in U.S. Pat. No. 6,420,048 B1 titled “High Molecular Weight Copolyesters from Macrocyclic Oligoesters and Cyclic Esters”, and U.S. Pat. No. 6,436,549 B1 titled “Block Copolymers from Macrocyclic Oligoesters and Dihydroxyl-Functionalized Polymers” both of which are expressly incorporated herein by reference for all purposes. Moreover, formation and other processing of such compounds, along with additional forms of such compounds are discussed in U.S. Pat. No. 6,369,157 B1 titled “Blend Material Including Macrocyclic Polyester Oligomers and Processes for Polymerizing the Same”, U.S. Pat. No. 6,420,047 B2 titled “Macrocyclic Polyester Oligomers and Processes for Polymerizing the Same”, and U.S. Pat. No. 6,436,548 B1 titled “Species Modification in Macrocyclic Polyester Oligomers, and Compositions Prepared Thereby” all of which are expressly incorporated herein by reference for all purposes. In a preferred sheet molding compound, macrocyclic oligoesters, or secondary compounds may be present in the sheet molding compound in an amount as high as 50% by weight of the sheet molding compound or higher and as low as 0.1% by weight of the sheet molding compound or lower. Preferably, the macrocyclic oligoesters or secondary compounds are present in the sheet molding compound in an amount between about 1% and about 30% by weight of the compound, more preferably in an amount between about 5% and about 20% by weight of the compound.

Though formation of homopolymers including the oligoesters herein are also contemplated, in a preferred embodiment, during molding of the sheet molding compound, the macrocyclic oligoesters and secondary compounds preferably form copolymers of high molecular weight in the presence of a suitable catalyst, and more preferably by transesterication using a suitable transesterification catalyst. The copolymers so prepared show favorable crystallinity and ductility while retaining other desirable properties of polymers prepared from macrocyclic oligoesters as precursors.

Accordingly, in one aspect, the sheet molding compound is provided with a macrocyclic oligoester and secondary compound selected from a cyclic ester other than a macrocyclic oligoester or a dihydroxyl-functionalized polymer. The macrocyclic oligoester and the secondary compound are contacted with each other in the presence of a transesterification catalyst at an elevated temperature (e.g., during molding) to produce a block copolymer such as a copolyester. Preferably, the macrocyclic oligoester has a structural repeat unit of formula (I):

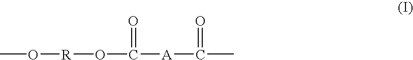

wherein R is an alkylene, a cycloalkylene, or a mono- or polyoxyalkylene group, and A is a divalent aromatic or alicyclic group. An example of a preferred ester is macrocyclic poly (alkylene dicarboxylide) other examples include macrocyclic oligoesters of 1,4-butylene terephthalate, 1,3-propylene terephthalate, 1,4-cyclohexylenedimethylene terephthalate, ethylene terephthalate, and 1,2-ethylene 2,6-naphthalenedicarboxylate, and macrocyclic co-oligoesters comprising two or more of the above structural repeat units.

In another aspect, during molding of the sheet molding compound, the macrocyclic oligoester is contacted with the transesterification catalyst at an elevated temperature to form a first polymeric segment. Subsequently, the first polymeric segment is contacted with the secondary compound and the transesterification catalyst at the elevated temperature thereby forming a second polymeric segment. The above steps then are sequentially repeated a desired number of times to form a block copolymer having additional first and second polymeric segments.

In another embodiment, molding of the sheet molding compound results in a variation of the above method of making a block copolymer. In particular, a first polymeric segment is formed by contacting the secondary compound and a transesterification catalyst at an elevated temperature. Subsequently, the first polymeric segment is contacted with a macrocyclic oligoester, and the transesterification catalyst at an elevated temperature thereby forming a second polymeric segment. The above steps then are sequentially repeated a desired number of times to form a block copolymer having additional first and second polymeric segments.

In yet another aspect, the sheet molding compound may be molded into a part having a block copolymer (e.g., a copolyester) that contains, within its polymeric backbone, at least one structural unit of formula (I) (as defined above) and at least one structural unit of formula (II):

—R₁-Q-C(O)—R₂ (II)

wherein R₁ and R₂ are independently an organic moiety with the proviso that R₁ is not —O-A′- if R₂ is —B′—C(O)—. A′ is an alkylene, a cycloalkylene, or a mono- or polyoxyalkylene group. B′ is a divalent aromatic or alicyclic group.

In yet another aspect, the sheet molding compound may be molded to form block copolymers (e.g., of polyesters). A first block unit of the copolymer has, within its polymeric backbone, at least one first structural unit of formula (I), as defined above. A second block unit has, within its polymeric backbone, at least one second structural unit of formula (II), as defined above.

Synthesis of the macrocyclic oligoesters may be achieved according to various methods and protocols. In brief, one preferred method includes contacting at least one diol of the formula HO—R—OH with at least one diacid chloride in the presence of at least one amine that has substantially no steric hindrance around the basic nitrogen atom. An illustrative example of such amines is 1,4-diazabicyclo[2.2.2]octane (DABCO). The reaction usually is conducted under substantially anhydrous conditions in a substantially water immiscible organic solvent such as methylene chloride. The temperature of the reaction typically is within the range of from about −25° C. to about 25° C. ˜, See U.S. Pat. No. 5,039,783 to Brunelle et al. incorporated herein by reference.

Macrocyclic oligoesters also can be prepared via the condensation of a diacid chloride with at least one bis(hydroxyalkyl) ester such as bis(4-hydroxybutyl) terephthalate in the presence of a highly unhindered amine or a mixture thereof with at least one other tertiary amine such as triethylamine. The condensation reaction is conducted in a substantially inert organic solvent such as methylene chloride, chlorobenzene, or a mixture thereof. See, e.g., U.S. Pat. No. 5,231,161 to Brunelle et al. incorporated herein by reference.

Another method for preparing macrocyclic oligoesters or macrocyclic co-oligoesters is the depolymerization of linear polyester polymers in the presence of an organotin or titanate compound. In this method, linear polyesters are converted to macrocyclic oligoesters by heating a mixture of linear polyesters, an organic solvent, and a transesterification catalyst such as a tin or titanium compound. The solvents used, such as o-xylene and o-dichlorobenzene, usually are substantially free of oxygen and water See e.g., U.S. Pat. No. 5,407,984 to Brunelle et al. and U.S. Pat. No. 5,668,186 to Brunelle et al. incorporated herein by reference.

It is also within the scope of the invention to employ macrocyclic co-oligoesters to produce block copolymers. Therefore, unless otherwise stated herein, references to macrocyclic oligoesters also includes embodiments utilizing macrocyclic co-oligoesters.

Dihydroxyl-functionalized polymers employed in various embodiments of the invention include any dihydroxyl-functionalized polymer that reacts with a macrocyclic oligoester to form a block copolymer under transesterification conditions. Illustrative examples of classes of dihydroxyl-functionalized polymers include polyethylene ether glycols, polypropylene ether glycols, polytetramethylene ether glycols, polyolefin diols, polycaprolactone diols, polyperfluoroether diols, and polysiloxane diols. Illustrative examples of dihydroxyl-functionalized polymers include dihydroxyl-functionalized polyethylene terephthalate and dihydroxyl-functionalized polybutylene terephthalate. The molecular weight of the dihydroxyl functionalized polymer used may be, but is not limited to, about 500 to about 100,000. In one embodiment, the molecular weight of the dihydroxyl-functionalized polymer used is within a range from about 500 to about 50,000. In another embodiment, the molecular weight of the dihydroxyl-functionalized polymer used is within a range from about 500 to about 10,000.

Cyclic esters (e.g., cyclic esters that are other than macrocyclic oligoesters) employed in various embodiments of the invention include any cyclic esters that react with a macrocyclic oligoester to form a copolymer (e.g., a copolyester) under transesterification conditions. Cyclic esters include lactones. The lactones may be a cyclic ester of any membered ring. In one embodiment, lactones of 5-10 membered rings are used. The lactone can be unsubstituted or substituted. One or more hydrogen atoms in the lactone structure can be substituted with a heteroatom such as O, N, or S. One or more hydrogen atoms in the basic lactone structure can be substituted with a halogen atom (e.g., F, Cl, Br or I) or other functional groups including alkyl groups (e.g., methyl, ethyl, propyl, butyl etc.), a hydroxy group, alkyloxy groups, a cyano group, amino groups, and aromatic groups. The lactone can contain one or more additional rings. Illustrative examples of lactones include lactide, gycolide, dioxanone, 1,4-dioxane-2,3-dione, ε-caprolactone, β-propiolactone, tetramethyl glycolide, β-butyrolactone, γ-butyrolactone and pivalolactone.

Catalysts employed to prepare the cyclic esters herein preferably are those capable of catalyzing a transesterification polymerization of a macrocyclic oligoester with secondary compound such as a a cyclic ester other than a macrocyclic oligoester or a dihydroxyl-functionalized polymer. One or more catalysts may be used together or sequentially. As with state-of-the-art processes for polymerizing macrocyclic oligoesters, organotin and organotitanate compounds are the preferred catalysts, although other catalysts may be used.

Illustrative examples of classes of tin compounds that may be used in the invention include monoalkyltin (IV) hydroxide oxides, monoalkyltin (IV) chloride dihydroxides, dialkyltin (IV) oxides, bistrialkyltin (IV) oxides, monoalkyltin (IV) trisalkoxides, dialkyltin (IV) dialkoxides, trialkyltin (IV) alkoxides or the like. Specific examples of organotin compounds that may be used in this invention include dibutyltin dioxide, 1,1,6,6-tetra-n-butyl-1,6-distanna-2,5,7,10-tetraoxacyclodecane, n-butyltin (IV) chloride dihydroxide, di-n-butyltin (IV) oxide, dibutyltin dioxide, di-n-octyltin oxide, n.-butyltin tri-n-butoxide, di-n-butyltin (IV) di-n-butoxide, 2,2-di-n-butyl-2-stanna-1,3-dioxacycloheptane, and tributyltin ethoxide. See e.g., U.S. Pat. No. 5,348,985 to Pearce et al., incorporated herein by reference. In addition, tin catalysts described in commonly owned U.S. Ser. No. 09/754,943 (incorporated by reference below) may be used in the polymerization reaction.

Titanate compounds that may be used in the invention include titanate compounds described in commonly owned U.S. Ser. No. 09/754,943 (incorporated herein by reference). Illustrative examples include tetraalkyl titanates (e.g., tetra(2-ethylhexyl) titanate, tetraisopropyl titanate, and tetrabutyl titanate), isopropyl titanate, titanate tetraalkoxide.

The weight ratio of the secondary compound to macrocyclic oligoester can vary from about 0.01 to 10. In one embodiment, the molar ratio of secondary compound to macrocyclic oligoester is between about 0.01 to about 0.1. In another embodiment, the molar ratio of secondary compound to macrocyclic oligoester is between about 0.1 to about 1.0. In yet another embodiment, the molar ratio of secondary compound to macrocyclic oligoester is between about 1.0 to about 5.0. In yet another embodiment, the molar ratio of secondary compound to macrocyclic oligoester is between about 5.0 to about 10.

The molar ratio of the transesterification catalyst to the macrocyclic oligoester can range from about 0.01 to about 10 mole percent. In one embodiment, the molar ratio of the catalyst to the macroeyclic oligoester is from about 0.01 to about 0.1 mole percent. In another embodiment, the molar ratio of the catalyst to the macrocyclic oligoester is from about 0.1 to about 1 mole percent. In yet another embodiment, the molar ratio of the catalyst to the macrocyclic oligoester is from about 1 to about 10 mole percent.

While it is preferable for certain of the sheet molding compounds to include both a macrocyclic oligoester and a secondary compound, it may also be preferable, in certain instances for the macrocyclic oligoester to react (e.g., polymerize) with itself, react with a different macrocyclic oligoester, react (e.g., polymerize) with a linker such as a diepoxide, combinations thereof or the like. In such cases, a block copolymer is still preferably formed, although it is not required. In cases where a macrocyclic oligoester reacts with another macrocyclic oligoester, such as itself (i.e., with a macrocyclic oligoester having an identical or substantially identical chemical formula) or with another different macrocyclic oligoester, a catalyst such as any of those mentioned herein is typically employed to assist the reaction. As an example, a macrocyclic oligoester might react with itself in the presence of a catalyst to form a polyester such as polybutylene terephthallate. Of course, secondary monomers, such as styrene or a vinyl ester, may be present (but aren't necessarily required) and the monomers may polymerize separately to produce a co-continuous phase or a separate phase.

In one exemplary alternative, it is contemplated that one or more compounds may be polymerized (e.g., copolymerized) to form a network or matrix and the macrocyclic oligoester may be integrated into the network or matrix by reaction or otherwise. For instance, in one embodiment, styrene, methyl methacrylate and a vinyl ester resin are copolymerized to produce a cross linked matrix. In turn, the macrocyclic oligoester (e.g., cyclic butylene terephthalate) may polymerize separately and may or may not react into the cross linked matrix. Thus, it is possible to have a cross linked matrix with the macrocyclic oligoester embedded in it, either as an interpenetrating network or as two separate phases. However, it is also possible to incorporate (e.g., react) the macrocyclic oligoester into the matrix using a reaction agent or linking agent such as glycidyl methacrylate.

Possible Resin Modifications

It is possible that the above resins are modified or otherwise further processed before admixture with other molding compound ingredients. For example, in one aspect, the oligoester of the resin may be reacted with another ingredient, such as by copolymerization with another component. To illustrate, it is contemplated that the ester is copolymerized with one or a combination of propylene carbonate, polyhydroxyethers, polyether polyols or the like. Preferably the molecular weight of the resulting ester copolymer thereby is increased relative to the ester by itself. Advantageously, these additional materials can provide the sheet molding compound with improved rheology during molding, better mechanical properties for parts formed with the molding compound and can allow for compounding of the sheet molding compound at lower temperatures.

As mentioned the preferred resin is employed in a molding compound and therefore preferably includes certain other ingredients, such as a molding compound catalyst, a filler or a reinforcement.

Catalysts

The sheet molding compound may include one or more molding compound catalysts in addition to the transesterification catalyst, for aiding in any necessary aging, curing, crosslinking or other reactions. For example, alternative or additional catalysts can include free radical initiators, organometallics (e.g., metal oxides) or the like and preferably are selected from oxide catalysts, peroxide catalysts, polyhydric initiators or the like. When employed the catalyst is present in an amount of about 0.01 to about 10% of the molding compound, and more preferably about 0.1 to 3%.

Reinforcement Materials

The sheet molding compound or resin may also include one or more different materials for providing reinforcement (e.g., strength, rigidity or the like) to the sheet molding compound. It is contemplated that any suitable reinforcement material may be employed in the present invention.

Examples of such fibers include, without limitation, polymeric fibers, metal fibers, carbon fibers, graphite fibres, ceramic fibers or combinations thereof. Specific examples include without limitation, polyamide (e.g., nylon, aromatic polyamide and polyamideimide) fibers, aramid fibers, polyester fibers, glass fibers, silicon carbide fibers, alumina fibers, titanium fibers, steel fibers, carbon fibers and graphite fibers or the like. It is also contemplated that reinforcement may be provided using the above materials but in a different form, such as chopped fiber, particulate, foam, woven, or unwoven fabric, mat, cordage, or otherwise. Of course, it is also contemplated that non-fibrous materials may be employed in the present invention. Optionally, the inforcement may be provided as a preformed shape. When employed, the reinforcement is present in the molding compound in an amount ranging from about 1 to 60%, and more preferably about 20 to 40%. It will also be appreciated from the further discussion herein that certain applications may employ reinforcement interchangeably with a suitable filler.

Other Ingredients

One or a combination of additional ingredients may be employed here to help improve or control one or more properties of the molding compound, such as strength, toughness, degradation resistance, rigidity, flexibility, hardness, thermal cycling, aesthetic properties such as smoothness, shape or the like or processablity properties such as flowability, rate of cure, toxicity, moldability or otherwise. Examples of such ingredients or agents, which generally may be employed in their art-disclosed amounts in the sheet molding compound include viscosity modifers, low profile or anti-shrink agents, corrosion inhibitors, flexibility modifying agents, mold release agents, phase stabilizing agents, UV stabilizers, plasticizers, fire-retardants, lubricants, anti-oxidants and mold releases.

It is contemplated that the sheet molding compound may include a flexibility modifying agent for increasing or decreasing the flexibility of the compound. For increasing flexibility, one or more relatively flexible polymers such as elastomers may be included in the sheet molding compound. Examples of suitable elastomers include nitrites, butadienes, EPDMs, halogenated elastomers (e.g., chloro- and fluoro-elastomers), silicone elastomers, polyurethane elastomers, latex, thermoplastic elastomers, olefinic elastomers and natural rubbers. For decreasing flexibility or increasing rigidity, one or more agents may be used such as cross-linkers, polymer reinforcing agents (e.g., nanocomposite polymers) or the like.

Other preferred functionals agents may be employed in the sheet molding compound as wells. Exemplary thickening agents include metallic oxides or hydroxides such as magnesium oxide or magnesium hydroxide. Exemplary mold release agents include zinc stearate, calcium stearate, magnesium stearate, organic phosphate esters, combinations thereof or the like. Exemplary phase stabilizing agents include fatty acids, dimer acids, trimer acids, polyester polyols combinations thereof or the like.

A variety of ingredients and their use in a molding compound can be gleaned from a review of illustrative U.S. Pat. Nos. 5,268,400 and 5,431,995, all of which are hereby incorporated by reference.

It is contemplated that the sheet molding compound of the present invention may include one or more linking agents (e.g., chain extension agents, cross-linking agents or the like), which react with and couple polymer chains (e.g, block copolymers or block copolyesters) formed in the sheet molding compound. Advantageously, these linking agents can provide properties such a rheological control, greater strength, greater molecular weight or the like to the sheet molding compound or the parts formed from the sheet molding compounds.

Fillers

The molding compound will typically include one or more fillers. Fillers for use herein preferably are particulated, but may also be fibrous or in some other suitable form such as clays, carbonates, fibrous material or the like. A filler is included in the sheet molding compound to achieve a desired characteristic or property. For example, a purpose of a filler may be to provide stability, (such as chemical, thermal or light stability), strength, processability or otherwise. A filler also may tailor a color, provide weight or bulk to achieve a particular density, provide flame resistance (i.e., be a flame retardant), be a substitute for a more expensive material, facilitate processing or achieve some other desired purpose.

Illustrative examples of fillers are, among others, fumed silicate, titanium dioxide, calcium carbonate, chopped fibers, fly ash, glass microspheres, micro-balloons, crushed stone, nanoclay, linear polymers, monomers, glass or plastic microspheres, silica materials, magnesium oxide, magnesium hydroxide, calcium oxide, calcium hydroxide. Typically, prior to addition of the reinforcement material, a reactive admixture (e.g., a paste), as further described below, used to form the molding compound may include up to 95% by weight or more fillers. Preferably, the reactive admixture includes between about 20% and about 90% by weight fillers, more preferably between about 30% and about 80% by weight fillers and even more preferably between about 40% and about 70% by weight fillers.

Advantageously, it has been found that the reactive admixture used for forming the sheet molding compound of the present invention can include a relatively large weight percent of filler while maintaining the ability to form strong parts. For such embodiments, the reactive admixture can include greater than about 30% by weight filler, greater than about 40% by weight filler and greater than about 50% or 60% by weight filler, but typically less about 90% by weigth filler. While any of the various fillers above may be included in the sheet molding compound, relatively high weight percentages of calcium carbonate (CaCO₃) have performed particularly well for maintaining strength of the parts. Without being bound by any theory, it is believed that the higher molecular weight polymers of the sheet molding compound of the present invention are at least partially responsible for maintaining part strength and that CaCO₃ does not interfere with the formation of such high molecular weight polymers.

In one preferred embodiment, a modified filler is employed so that the molding compound incorporates the function of a low profile agent. For forming one such modified filler, a filler such as a clay is modified by intercalating the filler with one or more macrocyclic oligoesters preferably prior to combining the modified filler with the other components of the sheet molding compound. Upon heating, or other suitable activation during molding of the sheet molding compound, the intercalated macrocyclic oligoester undergoes polymerization and causes the modified filler to exfoliate. In turn, the exfoliation of the modified filler causes a volumetric increase in the charge of compound that preferably offsets any shrinkage of the resulting molded article. Advantageously, this offsetting effect can provide parts that more closely mimic the surfaces of the mold and can also provide parts with surfaces that exhibit improved long term and short term distortion (e.g., waviness) in resulting parts.

In a highly preferred embodiment, one or more multifunctional (e.g, di- or tri-functional) compounds are provided as linking agents in the sheet molding compound for reacting with and coupling the polymer chains and particularly the block copolymers or copolyesters obtained by polymerizing the macrocyclic oligoester. Examples of such difunctional compounds include, without limitation, diepoxy resins, diepoxides, triepoxides, diisocyanates, diesters, combinations thereof or the like. When they are employed, they are present in an amount of about 1 to 30%.

According to another preferred embodiment, one or more reactive monomers may be provided as linking agents within the sheet molding compound. Exemplary reactive monomers include styrene, methyl methacrylate, peroxides for polymerizing vinyl monomers, unsaturated monomers (e.g., unsaturated acid, anhydride such as maleic anhydride, unsaturated polyester, unsaturated vinyl ester), combinations thereof or the like. Such reactive monomers can assist in improving rheological control, improving dimensional control, promoting easier handling during mold charging, increasing molecular weight of the copolymers or the like of the sheet molding compound or parts formed therewith. When they are employed, they are present in an amount of about 1 to 30%.

Another linking agent, which may be added to the sheet molding compound is an end-capped saturated polyester that may be provided as a polyol and can operate as a low profile agent. It has been found that end-capped saturated polyesters can aide microgel formation with the the sheet molding compound of the present invention. In turn, the dimensional stability of parts molded from the molding compound can maintain greater dimensional stability after formation. End capping of the saturated polyesters may occur terminating the polyester with a urethane or another compound. As examples, suitable urethane terminated polyester polyols include, without limitation, polycaprolactone terminated by a phenyl isocyanate, diethylene glycol adipate polyol terminated by phenyl isocyanate. When they are employed, they are present in an amount of about 1 to 30%.

The sheet molding compound may also include one or more additional materials in its resin and the additional materials may be polymeric materials resins or other materials. Polymeric materials suitable for the molding compound include, without limitation, plastics, thermosplastics, elastomers, plastomers, oils, combinations thereof or the like. The polymeric materials herein, it will be appreciated, may comprise polymers, copolymers or the like; or they may be part of a blends, composites or the like; or they may be provided in any other suitable form. The resins may be thermosetting resins or otherwise. Exemplary resins include, without limitation, matrix resins, epoxy resins, urea resins, melamine resins, phenol resins, polyurethane resins, polyol resins (e.g., polyester and polyether polyol resins), thermosetting resins, unsaturated polyester resins, diallyl phthalate resins, and thermoplastic resins such as polyamides, saturated or unsaturated polyesters, polybutylene terephthalates, polysulfones, polyether sulfones, polycarbonates, ABS, combinations thereof or the like.

Molding Compound Formation

It is contemplated that the various components of the sheet molding compound may be mixed and combined with each other by any suitable method and in any suitable order. For instance, the resin could be mixed with the filler prior to or after mixing the other components (e.g., the additives, the functional agents or the like) with the resin. Alternatively, only a portion of the resin ingredients may be mixed with various of the other components followed by addition of the remaining resin ingredients. It shall be appreciated that the skilled artisan will be able to imagine a myriad of mixing orders and techniques for forming a sheet molding compound according to the present invention.

According to one preferred method, one or more of the components such as the resin, the filler, the reinforcement material, the functional agents, the additives or any other components mentioned herein may be mixed in one or more mixers such as a Haake Mixer, a Drais Mixer, an extruder or the like for assisting in the formation of the molding compound. Although not required, such mixing preferably occurs at elevated temperatures.

It is also contemplated that the sheet molding compound may be prepared in a variety of configurations such as various shapes, thicknesses, densities or the like. The sheet molding compound may be internally continuous or non-continous (e.g, cellular). The sheet molding compound may be provided as a single portion or layer (e.g., as a batch), or alternatively, as a plurality of portions or layers and the portions or layers may be compositionally the same or different.

Moreover, the sheet molding compound may be provided with or without films. In one embodiment, the sheet molding compound is provided as a layer disposed adjacent to (e.g., sandwiched between) one or more films. The reinforcement materials may be included (e.g., integrated) in the sheet molding compound before, during or after applying the compound to the films. It is also contemplated that the one or more films may be sealed about the sheet molding compound for avoiding moisture absorption by the compound.

In one preferred embodiment, various components (i.e., the macrocyclic oligoesters, the cyclic esters, the dihydroxyl functionalized polymers, the filler, the catalyst, the additives, the functional agents or other components) of the sheet molding compound are formed into a reactive admixture (e.g., a polymeric paste), which may itself be considered a molding compound and which may or may not be heated. Thereafter, the reinforcement material is integrated into the admixture for completing the sheet molding compound.

The reinforcement material may be integrated with the reactive admixture according to a variety of techniques. For example, the reinforcement material may be applied to one or both of a first and second film followed by applying one or both of a first and second layer of the reactive admixture to one or both of the first and second films. Alternatively, one or both of the first and second layers of reactive admixture may be applied to the films followed by applying reinforcement material to one or both or the first and second layers. As another alternative, combinations of applying the reinforcement material to the first film, the second film, the first reactive admixture layer, the second reactive admixture layer may be employed. Regardless of the method of integrating the reinforcement material with the reactive admixture, it is preferable for one or both of the first layer and second layer of the reactive admixture to be sandwiched between the films and compressed together to integrate the reinforcement material in the resin and form the sheet molding compound.

For compressing the sheet molding compound, the molding compound and the films are fed to a system of rollers, which apply pressure to the molding compound and films thereby assisting in wetting the reinforcement materials with the polymeric resin materials and more fully integrating the reinforcement materials with resin. Optionally the rollers may be heated to further assist in the wetting and integration of the reinforcement material.

For any of the methods of integrating the reinforcement material into the sheet molding compound, a supplemental amount of a reactive admixture, which may have the same or a different composition as the original layers of reactive admixture, may be applied over the reinforcement material prior to sandwiching the sheet molding compound between the film. According to one preferred protocol, an additional amount of reactive admixture is sprayed in liquid form over the reinforcement material prior to sandwiching the sheet molding compound between the films. Advantageously, such supplemental reactive admixture can assist in wetting the reinforcement material for incorporation into the compound. In one embodiment, the supplemental reactive admixture also helps to hold the reinforcement materials stationary during sandwiching of the layers of reactive admixture and reinforcement materials between films.

The one or more films that preferably support the sheet molding compound may be formed of a variety of materials. Preferably, the films are polymeric films formed of materials such as plastics, elastomers, plastomers, thermoplastics or combinations thereof. More specifically, the films may be formed of polyolefins (e.g., polyethylenes, polyolefins, polypropylenes) or the like. In one preferred embodiment, the one or more films may be formed of materials that are compatible and even reactive with the sheet molding compound as will be further described below.

After formation, a sheet molding compound, in accordance with preferred aspects of the present invention, the compound may be molded into parts and optionally need not undergo a lengthy maturation process. Thus in one preferred embodiment, molding compounds according to the present invention are molded into parts upon conclusion of viscous thickening resulting from cooling of the sheet molding compound after mixing of the ingredients of the molding compound. Thus, in preferred embodiments of the invention, the molding compound is changed into a mold and molded into parts within 72 hours of their combination of ingredients, more preferably within 48 hours, even more preferably within 24 hours, and still more preferably within 12 hours. Thus from the time the ingredients are brought together in combination, less than one day may elapse, and it may even be possible to mold parts the same day, at the same manufacturing facility as the formation of the compound or at a remote and different one.

Of course, such rapid processing is not mandatory. In another embodiment, the materials of the invention may be stored for an extended period upon combination of ingredients. Advantageously, aspects of the present invention allow for lengthier shelf lives than conventional molding compound shelf lives, which are usually about 5-10 days. Thus, in preferred embodiments of the invention, the sheet molding compound can be molded into parts at least 10 days after formation, more preferably at least 14 days after formation, even more preferably at least 21 days after formation, and even still at least 30, 40, 50 or even 60 days after formation.

It should be recognized that these relatively short and relatively long time periods between sheet molding compound formation and the actual molding of the sheet compound allow for flexibility in processing of the compounds and parts. For instance, less storage space handling equipment and labor may be required for sheet molding compounds to age since the molding compounds of the present invention do not require substantial aging. As another example, sheet molding compound made at one facility may be more easily packaged and delivered to a second facility for forming parts since the longer shelf lives make the sheet molding compound less likely to expire or deteriorate. Thus the present invention contemplates a method of preparing a molding compound at a first facility and transporting the molding compound to a second facility for mlding into a desired article. Such transportation may be in a medium that is temperature regulated, or is substantially free of temperature regulation. Transportation to the second facility may occur within 12 hours of compound formation or longer.

Molding of the Sheet Molding Compound

Once formed, the molding compound may be molded or otherwise processed using a variety of techniques to achieve the desired configuration for the compound. For example, the compound may be compression molded, injection molded, pultruded or the like to form parts. Generally, molding of the compound includes placing the compound into a mold followed by applying elevated temperatures, elevated pressures or both within the mold such that the sheet molding compound assumes the shape of the mold.

During molding of the sheet molding compound, the co-polymerization reaction between a macrocyclic polyester oligomer and secondary compound (e.g., a cyclic ester, a dihydroxyl-functionalized polymer or both) is typically completed within minutes to form the copolymer (e.g., the copolyester). The duration of the co-polymerization reaction within the molding compound can depend on many factors including the molar ratio of the macrocyclic oligoester to the secondary compound, the molar ratio of the catalyst to the macrocylic oligoester and the secondary compound, the temperature at which the co-polymerization reaction is carried out, the desired molecular weight of the resulting block copolymer, and the choice of solvent and other reaction conditions. The molding of sheet molding compound is preferably conducted under a substantially inert environment, such as under nitrogen or argon, or under a vacuum.

The molding of the sheet molding compound for effecting the co-polymerization reaction is typically carried out at an elevated temperature. In one embodiment, the temperature at which the molding is conducted ranges from about 130° C. to about 300° C. In another embodiment, the temperature at which the molding is conducted ranges from about 130° C. to about 300° C. In yet another embodiment, the temperature at which the molding is conducted ranges from about 150° C. to about 260° C. In yet another embodiment, the temperature at which the molding is conducted ranges from about 170° C. to about 210° C. In yet another embodiment, the temperature at which the molding is conducted ranges from about 180° C. to about 190° C.

Yields of block copolymer within the sheet molding compound depend on, among other factors, the precursor macrocyclic oligoester(s) used, the secondary compound used, the polymerization catalyst(s) used, the reaction time, the reaction conditions, the presence or absence of linking agent(s), and the work-up procedure. Typical yields range from about 90% to about 98% of the macrocyclic oligoester used. In one embodiment, the yield is within a range from about 92% to about 95%.

Block copolymers within the sheet molding compound may be designed and prepared according to methods of the invention to achieve desired elasticity, crystallinity, and/or ductility. Block copolymers having a high weight percentage of the dihydroxyl-functionalized polymer content (e.g., polytetramethylene ether glycol), for example, exhibit an increased toughness and become elastomeric. Similar block copolymers having a low weight percentage of the dihydroxyl-functionalized polymer content exhibit an increased elasticity.

The resulting high molecular weight block copolymer formed within the sheet molding compound may have a molecular weight within a range from about 10,000 to 300,000. In one embodiment, the molecular weight of the block copolymer is within a range from about 10,000 to about 70,000. In another embodiment, the molecular weight of the block copolymer is within a range from about 70,000 to about 150,000. In yet another embodiment, the molecular weight of the block copolymer is within a range from about 150,000 to about 300,000. Advantageously, these molecular weights can be increased up to or greater than 5%, more preferably greater than 10%, and even more preferably greater than 15 or 20% when linking agents or other molecular weight increasing techniques discussed herein are employed. Advantageously, these high molecular weights can result in molded parts with superior mechanical properties.

If the sheet molding compound is supported by or layered upon one or more films, the one or more films may be removed prior to molding of sheet molding compound. However, according to one preferred embodiment, the one or more films may be formed of materials that are compatible and even reactive with the sheet molding compound such that the films can be molded with the sheet molding compound.

It is contemplated that various films may be used with various sheet molding compounds depending upon the compatability of the films with the compounds during molding. According to one preferred embodiment, the one or more films are formed of a polyester resin such as polyethylene terephthallate or polybutylene terephthalate.

Advantageously, molding of the sheet molding compounds together with the films that are layered upon can reduce costs by reducing the labor used to removed the films prior to molding. Additionally, films do not need to create any additional waste during molding. Surprisingly, it has been found, particularly in the above preferred embodiment, that molding of the films with the sheet molding compound can produce laminated parts, which exhibit increased strength.

The sheet molding compound of the present invention may be used to manufacture articles of various size and shape. Exemplary articles that may be manufactured by molding the compound include, without limitation, automotive structural or decorative components and body panels and chassis components, bumper beams, boat hulls, aircraft wing skins, windmill blades, fluid storage tanks, rail cars, snipping containers, luggage, shelving, flooring, walls, tractor fenders, tennis rackets, applicance housings, golf shafts, sail masts, toys, rods, tubes, bars stock, bicycle forks, and machine housings.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. In particular regard to the various functions performed by the above described components, assemblies, devices, compositions, etc., the terms used to describe such items are intended to correspond, unless otherwise indicated, to any item that performs the specified function of the described item, even though not necessarily structurally equivalent to the disclosed structure. In addition, while a particular feature of the invention may have been described above with respect to only one of the embodiments, such feature may be combined with one or more other features of other illustrated embodiments.

What is claimed is:

1. A method of molding a sheet molding compound having a reaction agent for increasing the molecular weight, the physical properties or both of the sheet molding compound, comprising:
combining a macrocyclic oligoester and a reactive compound with a transesterification catalyst thereby forming a reactive admixture wherein the reactive compound is selected from another macrocyclic oligoester or a secondary compound;
combining the reactive admixture with a linking agent and a reinforcement material to form the sheet molding compound; and
molding the sheet molding compound at an elevated temperature wherein;
i) the macrocyclic oligoester reacts with the reactive compound in the presence of the transesterification catalyst to produce a block copolymer; and
ii) the linking agent couples chains of the block copolymer together thereby increasing the molecular weight of the block copolymer.

2. A method as in claim 1, wherein the linking agent is a reaction agent selected from a diepoxy resin, a diepoxide, a diisocyanate, a diester or a combination thereof.

3. A method as in claim 1 wherein an end-capped saturated polyester selected from a polycaprolactone terminated by a phenyl isocyanate and a diethylene glycol adipate polyol terminated by phenyl isocyanate are present for assisting in maintaining greater dimensional stability.

4. A method as in claim 1 wherein the linking agent is a reactive monomer selected from a styrene, a methyl methacrylate or a peroxide.

5. A method as in claim 1 further comprising:
combining a filler with the reactive admixture wherein the filler and the reinforcement material represent at least about 50% by weight of the sheet molding compound.

6. A method as in claim 5 wherein the filler is calcium carbonate.

7. A method as in claim 1 wherein the macrocyclic ester, the secondary compound or both are present in the sheet molding compound in an amount between about 1% and about 30% by weight.

8. A method as in claim 1, further comprising:
applying the sheet molding compound to one or more plastic films, the plastic films being at least partially formed of a polyester resin wherein, upon molding, the sheet molding compound is integrated with the one or more plastic films in the one or more parts.

9. A method as in claim 1, further comprising:
admixing into the molding compound, a low profile agent including a clay that is intercalated with a macrocyclic oligoester; wherein exfoliation of the clay during polymerization of the macrocyclic oligoester increases volume for offsetting shrinkage.

10. A method as in claim 1 wherein the step of molding the sheet molding compound occurs in a time period selected from within 24 hours of forming the admixture or no less than 10 days after forming the admixture.

11. A method as in claim 1 wherein the macrocyclic oligoester has a structural repeat unit of formula: 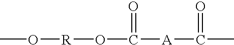
wherein R is an alkylene, a cycloalkylene, or a mono- or polyoxyalkylene group, and A is a divalent aromatic or alicyclic group.

12. A method of molding a sheet molding compound into one or more parts, comprising:
combining a macrocyclic oligoester and a secondary compound selected from a cyclic ester or a dihydroxyl-functionalized polymer with a transesterification catalyst to form a reactive admixture;
combining the reactive admixture with a reinforcement material to form the sheet molding compound;
applying the sheet molding compound to one or more plastic films, the plastic films being at least partially formed of a polyester resin; and
molding the sheet molding compound with the one or more plastic films at an elevated temperature to form one or more parts wherein;
i) the macrocyclic oligoester react with the secondary compound in the presence of the transesterification catalyst to produce a block copolymer of polyester and the secondary compound; and
ii) the sheet molding compound is integrated with the one or more plastic films in the one or more parts.

13. A method as in claim 12, further comprising:
admixing into the molding compound, a low profile agent including a clay that is intercalated with a macrocyclic oligoester; wherein exfoliation of the clay during polymerization of the macrocyclic oligoester increases volume for offsetting shrinkage.

14. A method as in claim 12 wherein the step of molding the sheet molding compound occurs in a time period selected from within 24 hours of forming the admixture or no less than 10 days after forming the admixture.

15. The method of claim 12 wherein the steps of combining the admixture with the reinforcement material and applying the sheet molding compound to the one or more plastic films occur at least partially simultaneously.

16. A method of forming a low-shrinkage molding compound into one or more parts, comprising:
providing a molding compound that includes at least one of a macrocyclic oligoester and a secondary compound selected from a cyclic ester or a dihydroxyl-functionalized polymer with a transesterification catalyst to form a reactive admixture; and
admixing into the molding compound, a low profile agent including a clay that is intercalated with a macrocyclic oligoester; wherein exfoliation of the clay during polymerization of the macrocyclic oligoester increases volume for offsetting shrinkage.

17. A method as in claim 16, further comprising:
molding the sheet molding compound to form one or more parts wherein the step of molding the sheet molding compound occurs in a time period selected from within 24 hours of forming the admixture or no less than 10 days after admixing the low profile agent into the molding compound.

18. A method of forming a sheet molding compound into one or more parts, comprising:
combining a macrocyclic oligoester and a secondary compound selected from a cyclic ester or a dihydroxyl-functionalized polymer with a transesterification catalyst to form a reactive admixture;
combining a reinforcement material with the admixture to form the sheet molding compound;
molding the sheet molding compound at an elevated temperature to form one or more parts wherein;
i) the macrocyclic oligoester reacts with the secondary compound in the presence of the transesterification catalyst to produce a block copolymer of polyester and the secondary compound; and
ii) the step of molding the sheet molding compound occurs in a time period selected from within 24 hours of forming the admixture or no less than 10 days after forming the admixture.

19. A method as in claim 18 wherein the macrocyclic oligoester has a structural repeat unit of formula: 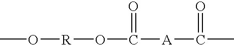
wherein R is an alkylene, a cycloalkylene, or a mono- or polyoxyalkylene group, and A is a divalent aromatic or alicyclic group.

20. A method of molding a sheet molding compound into one or more parts, comprising:
combining a macrocyclic oligoester and a secondary compound selected from a cyclic ester or a dihydroxyl-functionalized polymer with a transesterification catalyst to form a reactive admixture;
combining the reactive admixture with a reinforcement material to form the sheet molding compound wherein the reactive admixture is combined with the reinforcement material according to a technique selected from;
i) applying the reinforcement material to one or more plastic films; coating the one or more films and the reinforcement material with a supplemental reactive admixture in liquid form; and applying the reactive admixture to the one or more films;
ii) applying the reactive admixture to the one or more plastic films; applying the reinforcement material to the admixture; and coating the reactive admixture and the reinforcement material with a supplemental reactive admixture in liquid form; or
iii) a combination thereof; and
molding the sheet molding compound with the one or more plastic films at an elevated temperature to form one or more parts wherein;
i) the macrocyclic oligoester react with the secondary compound in the presence of the transesterification catalyst to produce a block copolymer of polyester and the secondary compound.
